(19) United States
(12) Patent Application Publication
(10) Pub. No.: US 2004/0149101 A1
(43) Pub. Date: Aug. 5, 2004

(54) Slitter knife system

(76) Inventor: Gary I. Solberg, Fort Oglethorpe, GA (US)

Correspondence Address: Michael S. Neustel, Suite No. 4, 2534 South University Drive, Fargo, ND, 58103, US

(21) Appl. No.: 10/360,306

(22) Filed: Feb. 5, 2003

(51) Int. Cl. B26D 7/06; B26B 1/00; B26D 1/00

(52) U.S. Cl. 83/431; 83/698.41

(57) ABSTRACT

A slitter knife system for facilitating efficient changing of cutting knives upon a slitting machine. The slitter knife system includes an axle member with a first passage attachable to a slitter machine, an arbor member rotatably attached about the axle member, a plurality of bores extending into a front face of the arbor member and fluidly connected to a second passage, a connector member fluidly connecting the first passage and the second passage, a stud shaft movably extending from each of the bores, and a clamp member having a plurality of guide apertures that catchably receive each stud shaft. Each stud shaft is retracted into the respective bore when pressurized fluid or gas is provided into an inlet port of the first passage thereby drawing the clamp member upon an upper knife positioned upon the arbor member.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to slitting machines and more specifically it relates to a slitter knife system for facilitating efficient changing of cutting knives upon a slitting machine.

2. Description of the Related Art

Slitter machines have been in use for years for cutting a continuous web of material into strips such as paper, polyethylene, polypropylene, polyester, film laminates, pressure sensitive label stock, extensible films, plastic, rubber, textile, film, metalized films, and various other flexible materials. Illustrations of patented slitter machines are disclosed within U.S. Pat. No. 5,083,489 to Tidland et al. and U.S. Pat. No. 6,253,652 to Dax et al. A manufacturer of slitting machines and other accessories is MAXCESS INTERNATIONAL which produces slitting machines under the brand name TIDLAND.

Conventional slitter machines are comprised of a circular upper knife (also called a “rotary shear knife” or “male knife”) that overlaps with a lower knife (also called the “female knife”) to provide a scissors-like action for cutting a continuous roll of material as the material is pulled between the upper knife and the lower knife. The upper knife is typically a non-powered rotary cutting disk rotatably attached within a carriage which is attached to a transverse bar member. The upper knife typically ranges from 2 inches to 24 inches in diameter depending upon the application. A plurality of carriages may be attached to the transverse bar member to create parallel strips of various widths. The lower knife may be a blade supported from underneath the roll or a roller/drum having a sharpened edge. The upper knife and the lower knife create a shearing action against the continuous material as it unwinds from a roll and is pulled through the slitter machine by a rewind or a take-up roll.

The upper knives of the slitter machine often times require replacement upon becoming damaged or dulled. The process of changing the upper knife can be time consuming and makes the slitter machine non-operational for extended periods of time which is extremely costly. FIGS. 11 and 12 of U.S. Pat. No. 5,083,489 provides an example of the structure that retains the upper knife (20) which requires the loosening of three bolts (154) and then the rotation of the retaining ring (138) to remove the upper knife from the carriage structure. There are various other upper knife changing systems that typically require the loosening or removal of a plurality of bolts from the carriage structure.

The main problem with conventional slitter machines is that it is time consuming to replace the upper knives after they have become damaged or worn. A further problem with conventional slitter machines is that they require the entire slitter machine to be non-operational for extended periods of time during the replacement of the upper knives which is costly to for the owner of the slitter machine.

While these devices may be suitable for the particular purpose to which they address, they are not as suitable for facilitating efficient changing of cutting knives upon a slitting machine. Conventional slitter machines do not provide for an efficient system for replacing the upper knives thereby costing the owner of the slitter machine significant amounts of time and money.

In these respects, the slitter knife system according to the present invention substantially departs from the conventional concepts and designs of the prior art, and in so doing provides an apparatus primarily developed for the purpose of facilitating efficient changing of cutting knives upon a slitting machine.

### BRIEF SUMMARY OF THE INVENTION

In view of the foregoing disadvantages inherent in the known types of slitting machines now present in the prior art, the present invention provides a new slitter knife system construction wherein the same can be utilized for facilitating efficient changing of cutting knives upon a slitting machine.

The general purpose of the present invention, which will be described subsequently in greater detail, is to provide a new slitter knife system that has many of the advantages of the slitting knife systems mentioned heretofore and many novel features that result in a new slitter knife system which is not anticipated, rendered obvious, suggested, or even implied by any of the prior art slitter devices, either alone or in any combination thereof.

To attain this, the present invention generally comprises an axle member with a first passage attachable to a slitter machine, an arbor member rotatably attached about the axle member, a plurality of bores extending into a front face of the arbor member and fluidly connected to a second passage, a connector member fluidly connecting the first passage and the second passage, a stud shaft movably extending from each of the bores, and a clamp member having a plurality of guide apertures that catchably receive each stud shaft. Each stud shaft is retracted into the respective bore when pressurized fluid or gas is provided into an inlet port of the first passage thereby drawing the clamp member upon an upper knife positioned upon the arbor member.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a slitter knife system that will overcome the shortcomings of the prior art devices.

A second object is to provide a slitter knife system for facilitating efficient changing of cutting knives upon a slitting machine.

Another object is to provide a slitter knife system that significantly reduces the amount of time to replace cutting knives upon a slitting machine.

An additional object is to provide a slitter knife system that may be utilized with various designs and structures of slitting machines.

A further object is to provide a slitter knife system that significantly reduces the amount of time the slitter machine is out of operation during the changing of the slitter knives.

Another object is to provide a slitter knife system that is cost effective to utilize within the slitter industry.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an exploded upper perspective view of the present invention.

FIG. 2 is a side view of the present invention.

FIG. 3 is a front view of the clamp member showing the main apertures, the first slot portions and the recessed portions for receiving the stud shafts.

FIG. 4 is an exploded side view of the present invention.

FIG. 5 is an exploded side cutaway view of the present invention.

FIG. 6 is a side cutaway view of the present invention with the piston members pressurized drawing the stud shafts against the clamp member.

FIG. 7 is a side cutaway view of the present invention with the piston members depressurized allowing the stud shafts to be extended from the clamp member by the compression springs.

FIG. 8 is a side cutaway view of the present invention with the clamp member and the upper knife removed from the arbor member.

FIG. 9 is an upper perspective view of the present invention with an upper knife tightly retained upon the arbor member.

FIG. 10 is an upper perspective view of the present invention with the stud shafts extended outwardly.

FIG. 11 is an upper perspective view of the present invention with the stud shafts extended outwardly and the clamp member rotated so that the stud shafts are positioned within the main apertures of the clamp member.

FIG. 12 is an exploded upper perspective view of the connector member fully removed from the stud shafts and the arbor member thereby allowing for removal of the upper knife.

### DETAILED DESCRIPTION OF THE INVENTION

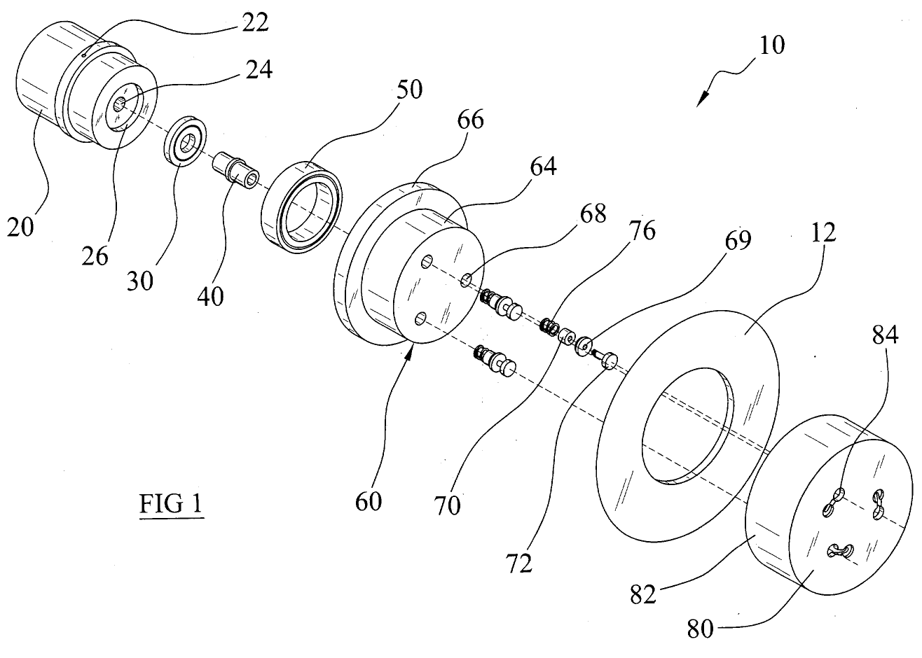

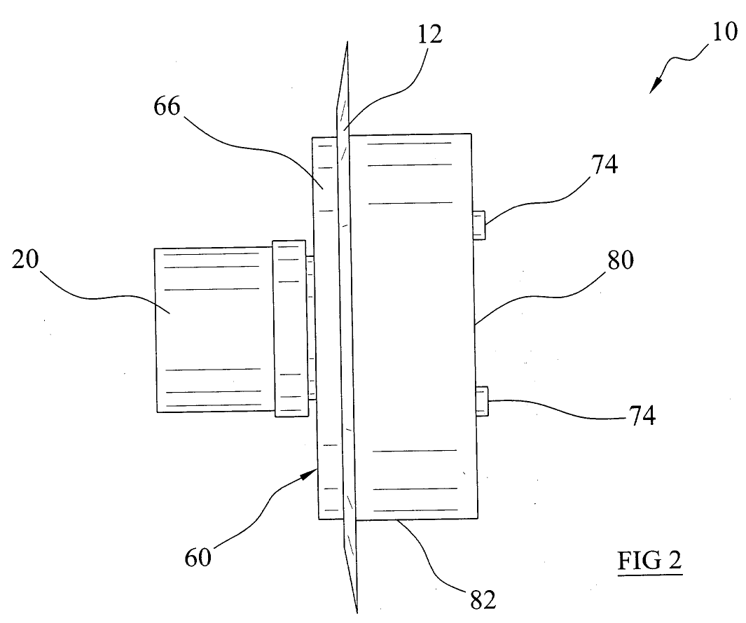

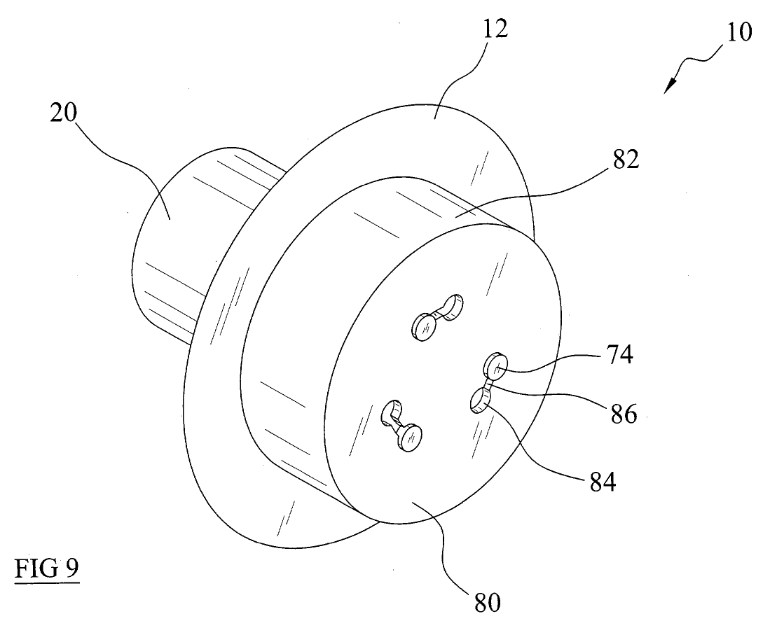

Turning now descriptively to the drawings, in which similar reference characters denote similar elements throughout the several views, FIGS. 1 through 12 illustrate a slitter knife system 10, which comprises an axle member 20 with a first passage 24 attachable to a slitter machine, an arbor member 60 rotatably attached about the axle member 20, a plurality of bores 68 extending into a front face of the arbor member 60 and fluidly connected to a second passage 63, a connector member 40 fluidly connecting the first passage 24 and the second passage 63, a stud shaft 72 movably extending from each of the bores 68, and a clamp member 80 having a plurality of guide apertures that catchably receive each stud shaft 72. Each stud shaft 72 is retracted into the respective bore 68 when pressurized fluid or gas is provided into an inlet port 22 of the first passage 24 thereby drawing the clamp member 80 upon an upper knife 12 positioned upon the arbor member 60.

As shown in FIGS. 1, 2, 4 and 5 of the drawings, the axle member 20 is preferably an elongate structure. The axle member 20 may be comprised of various shapes, structures and sizes other than that illustrated in the attached drawings capable of rotatably supporting the arbor member 60 with an upper knife 12.

It can be appreciated that the axle member 20 may be attached to various types of slitting machines. It can also be appreciated that the axle member 20 may be connected to the slitting machine in a movable or non-movable manner commonly utilized within the industry. U.S. application Ser. No. 10/117,842 illustrates an exemplary movably structure for supporting the axle member 20 in a movable manner which may be utilized with the present invention.

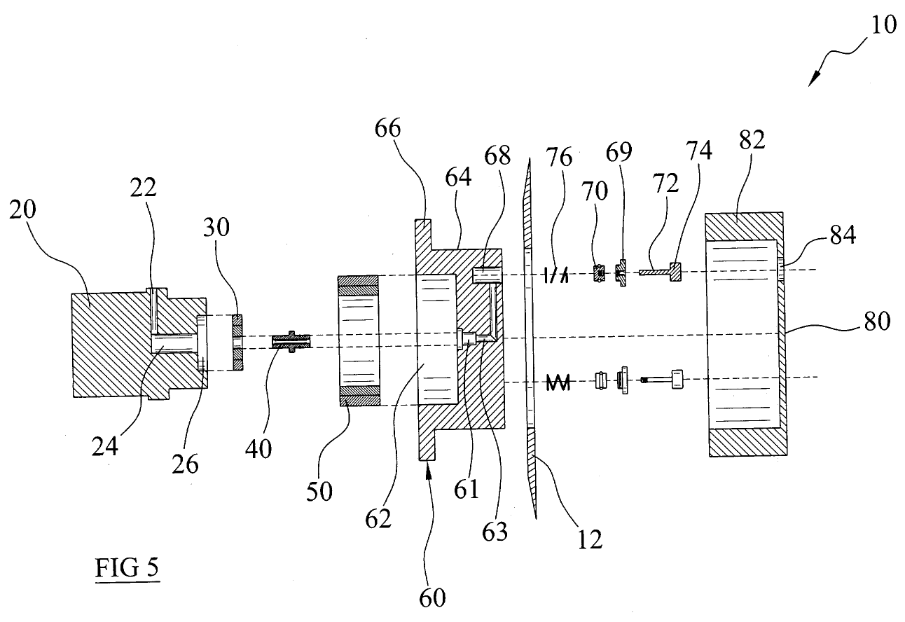

An inlet port 22 extends into the axle member 20 and is fluidly connected to a first passage 24 as shown in FIGS. 5 through 8 of the drawings. The first passage 24 and the inlet port 22 are formed for receiving a fluid or gas under pressure in a sealed manner. A portion of the first passage 24 preferably extends concentrically with respect to the arbor member 60. A gas pressure or fluid pressure unit is fluidly attached to the inlet port 22 to provide the pressurized gas or fluid to the present invention which are commonly utilized.

As shown in FIG. 5 of the drawings, a front end of the axle member 20 includes an axle cavity 26 for receiving a connector bearing 30. The connector bearing 30 has a center aperture within that receives a tubular connector member 40 as shown in FIG. 5 of the drawings. The connector member 40 is thereby rotatably retained within the connector bearing 30 thereby allowing a non-movable and fluid connection to the second passage 63 within the arbor member 60. The connector bearing 30 is preferably substantially sealed within the axle member 20 to prevent pressurized fluid from escaping through or about the connector bearing 30.

The arbor member 60 has an arbor cavity 62 that receives the arbor bearing 50 shown in FIG. 5 of the drawings. The arbor bearing 50 is rotatably attached to the axle member 20 thereby allowing the arbor member 60 to rotate upon the axle member 20 with the upper knife 12 during the operation of the slitting machine. The arbor member 60 has a receiver portion 64 for receiving the upper knife 12 and a flanged section 66 that the upper knife 12 is abutted against when the clamp member 80 is tightened upon the upper knife 12.

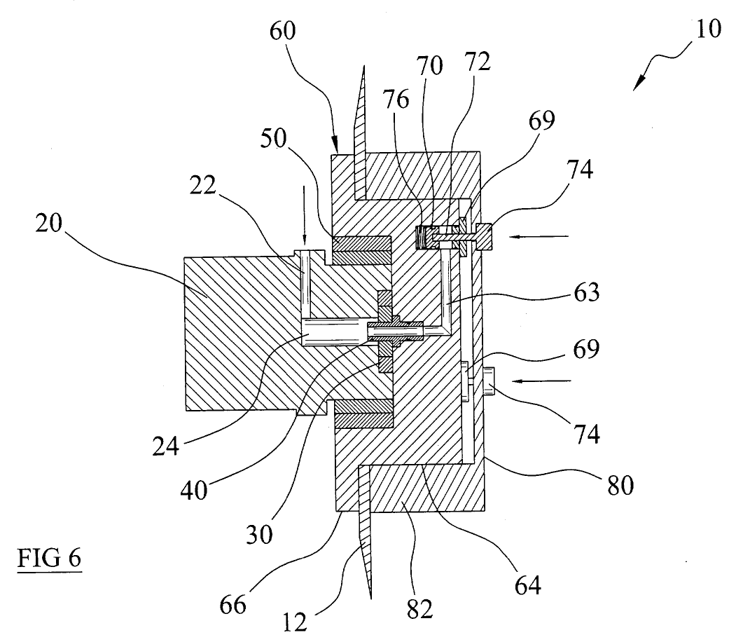

A receiver passage 61 is positioned centrally within the arbor bearing 50 for sealably receiving the end of the tubular connector member 40 opposite of the connector bearing 30 as shown in FIG. 5 of the drawings. The receiver passage 61 is preferably concentrically positioned within the arbor member 60 as shown in FIGS. 6 through 8 of the drawings.

The second passage 63 is fluidly connected to the receiver passage 61 as further shown in FIG. 5 of the drawings. The second passage 63 has one or more branch passages that are fluidly connected to a respective bore 68 within the arbor member 60. The bores 68 within the arbor member 60 are extended into the face of the arbor member 60 corresponding to the position of main apertures 84 within the clamp member 80. FIG. 1 illustrates the usage of three bores 68, however it can be appreciated that any number of bores 68 may be utilized in order to provide sufficient stability to the upper knife 12 and the clamp member 80 during operation of the slitter machine. Each bore 68 extends a finite distance into the arbor member 60 sufficient for movably receiving the piston member 70. The branch passage extending from the second passage 63 that corresponds to each bore 68 preferably is fluidly connected to the corresponding bore 68 in the front portion thereof for allowing pressurized fluid or gas to force the piston member 70 inwardly within the bore 68.

As shown in FIGS. 6 through 8 of the drawings, a compression spring 76 is positioned within a rear portion of each bore 68. A piston member 70 is slidably positioned within each bore 68 adjacent the compression spring 76 as further shown in FIGS. 6 through 8 of the drawings. The piston member 70 is sealed within the bore 68 and is positioned so as to leave the branch passage open at least a finite amount. The piston member 70 may include one or more seals within the exterior portion of the piston member 70 for facilitating the sealing of the piston member 70 within the bore 68. A cap member 69 is sealably secured to the front end of each bore 68, wherein each cap member 69 contains a center aperture with a seal for receiving the stud shaft 72 in a slidable and sealed manner. The cap member 69 may be secured within the bore 68 using conventional fastening devices and systems.

A stud shaft 72 slidably extends through each cap member 69 and is attached to each piston member 70 as illustrated in FIGS. 6 through 8 of the drawings. The distal end of the stud shaft 72 includes a flanged portion 74. The flanged portion 74 preferably has a circular cross sectional shape as illustrated in the drawings, however various other cross sectional shapes may be utilized to form the flanged portion 74 such as but not limited to square, oval, rectangle, triangle and the like. The flanged portion 74 is formed to snugly fit within a corresponding recessed portion 88 of the arbor member 60.

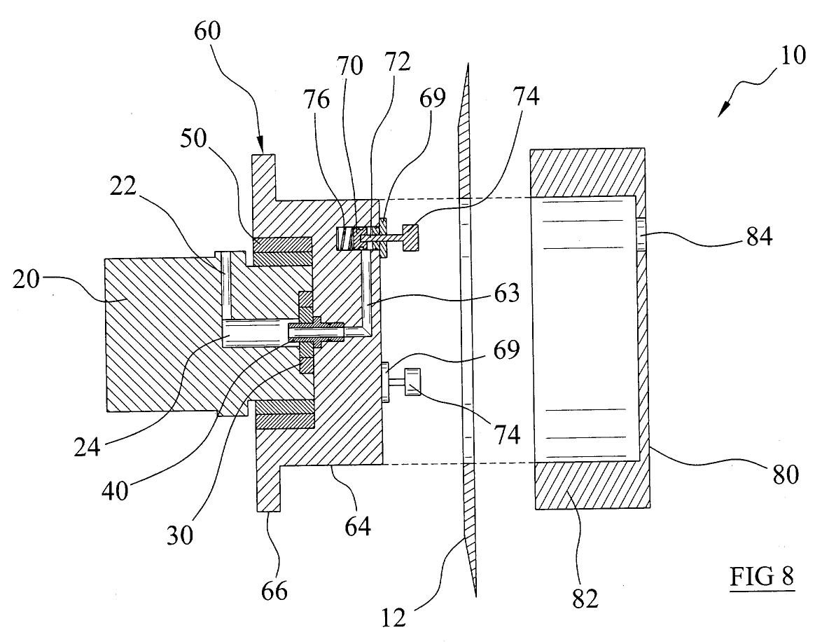

As shown in FIGS. 1 and 8 of the drawings, the clamp member 80 has an extended lip portion 82 that is formed to slidably pass about the receiver portion 64 of the arbor member 60 to engage an upper knife 12 against the flanged section 66 of the arbor member 60. The clamp member 80 may have various shapes and sizes as required to retain the upper knife 12 upon the arbor member 60 in a removable manner.

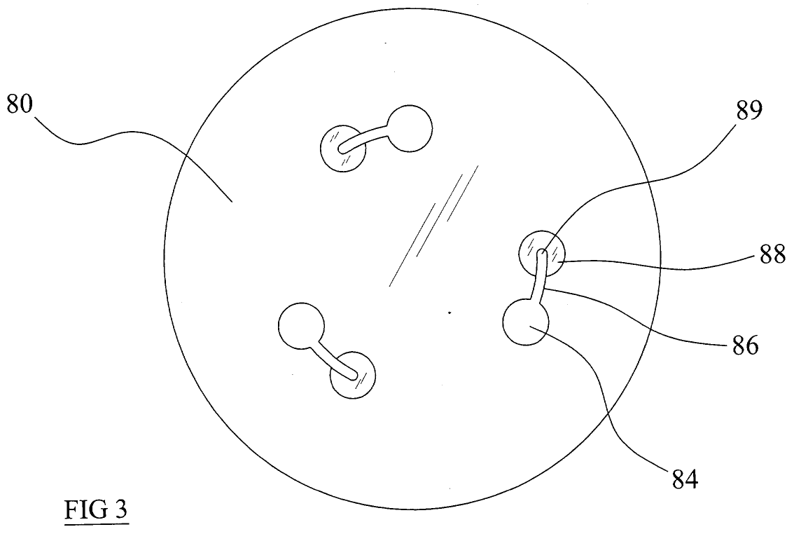

As shown in FIG. 3 of the drawings, the clamp member 80 includes a plurality of openings for receiving a corresponding stud shaft 72 with flanged portion 74. The plurality of openings are each comprised of a main aperture 84, a fist slot portion extending from the main aperture 84, a recessed portion 88 extending into the front face of the arbor member 60, and a second slot portion 89 extending from the first slot portion 86 to a central position within the recessed portion 88.

The main aperture 84 has a size sufficient for allowing the flanged portion 74 of the stud shaft 72 to freely pass through during removal and attachment of the clamp member 80 upon the arbor member 60. The first slot portion 86 extends from an edge of the main aperture 84 and is preferably curved with a constant radius measured from a center point of the arbor member 60. The first slot portion 86 has a width greater than a width of the stud shaft 72, but less than the width of the flanged portion 74. The first slot is preferably slightly larger in width than the width of the stud shaft 72 for providing proper alignment of the clamp member 80 upon the arbor member 60.

The recessed portion 88 is formed for snugly receiving the flanged portion 74 of the stud shaft 72 as best illustrated in FIG. 6 of the drawings. The recessed portion 88 is preferably formed to the shape and size of the flanged portion 74 as further shown in FIG. 1 of the drawings. A second slot portion 89 extends from the first slot portion 86 forming a single slot structure with a common radius. The second slot extends to a central location within the recess portion thereby allowing the stud shaft 72 to extend centrally within the recessed portion 88 and the flanged portion 74 to be drawn into the recessed portion 88.

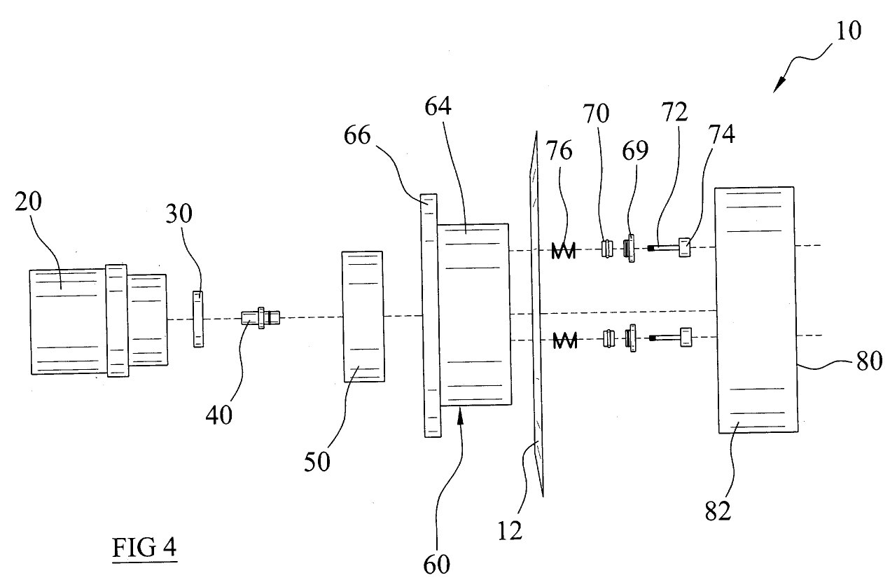

For installing an upper knife 12, the user positions the upper knife 12 upon the receiver portion 64 of the arbor member 60 as shown in FIGS. 4, 5 and 8 of the drawings. The clamp member 80 is then positioned so that the flanged portion 74 of each stud shaft 72 is aligned with the corresponding main aperture 84. The clamp member 80 is then positioned upon arbor member 60 with the flanged portions 74 extending through the main apertures 84 within the clamp member 80. The clamp member 80 is then rotated so that the first slot portion 86 and the second slot portion 89 slidably receive the stud shaft 72 until the flanged portion 74 is substantially concentric with the recessed portion 88. Pressurized fluid or gas is then provided into the first passage 24 which passes through the tubular connector member 40 into the second passage 63 and thereafter into the branch passages connected to each bore 68. The pressurized fluid or gas then enters each bore 68 on the front side of each piston member 70 thereby forcing each piston member 70 rearwardly toward the rear portion of the bore 68. As each piston member 70 is drawn inwardly into the respective bore 68, the corresponding stud shaft 72 with flanged portion 74 is drawn inwardly so that the flanged portion 74 is tightly received within the recessed portion 88 of the arbor member 60 thereby drawing the clamp member 80 tight against the upper knife 12. The upper knife 12 is now snugly retained between the lip portion 82 of the clamp member 80 and the flanged section 66 of the arbor member 60. The user may then move the upper knife 12 to the proper position for cutting the sheet material with respect to a lower knife of the slitter machine. The upper knife 12 is then free to rotate with respect to the axle member 20 while allowing the pressurized fluid or gas to retain the clamp member 80 in a tight relationship upon the arbor member 60.

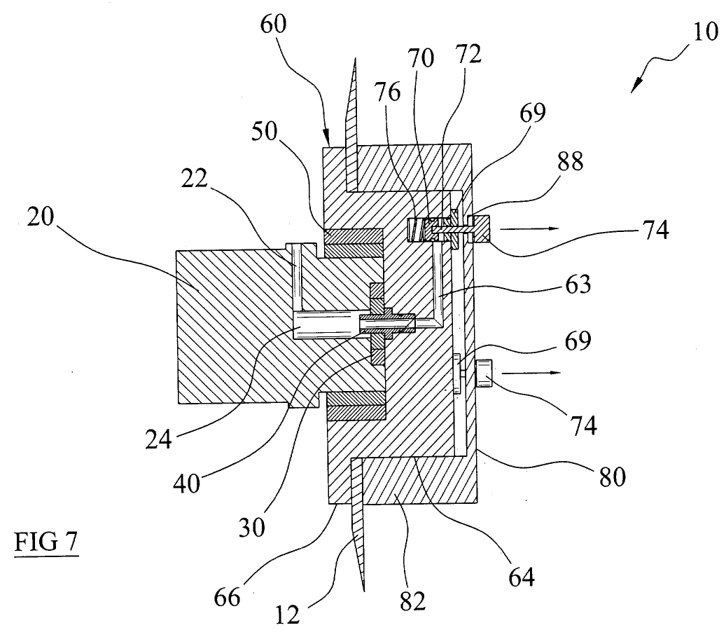

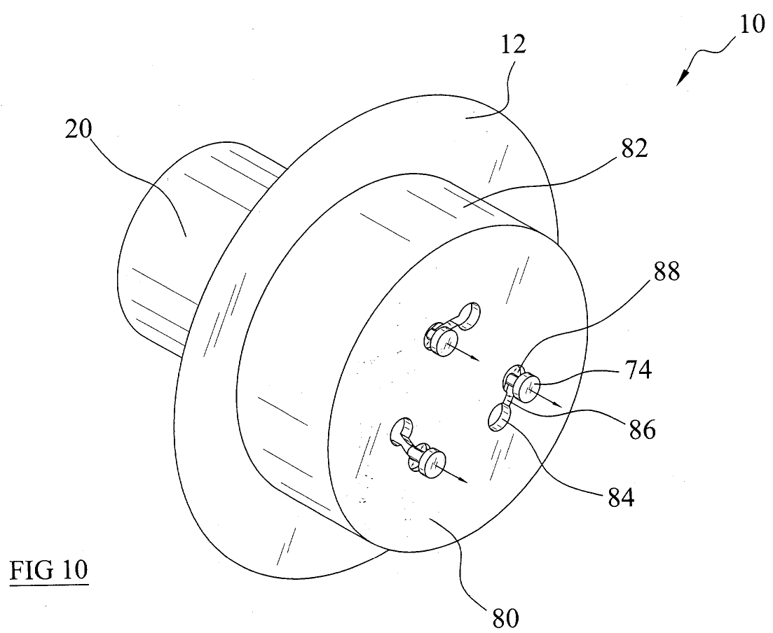

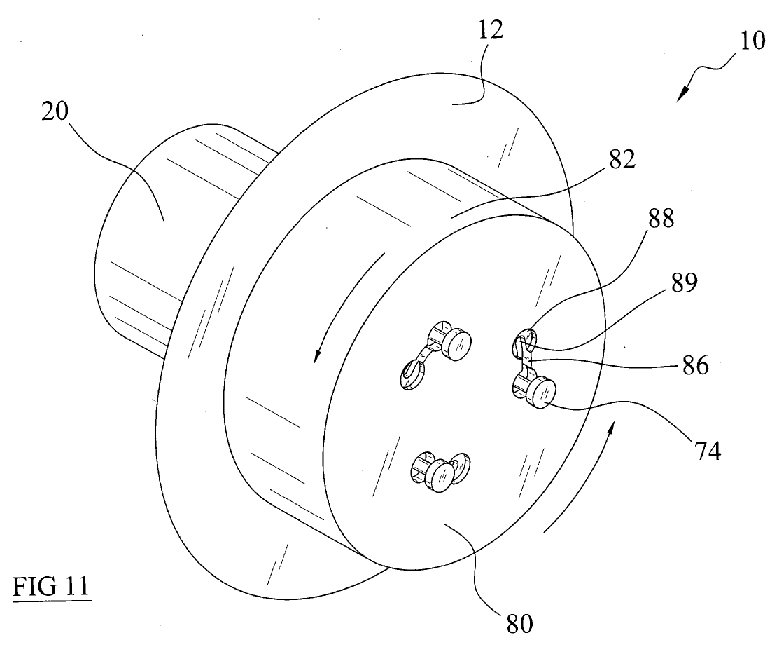

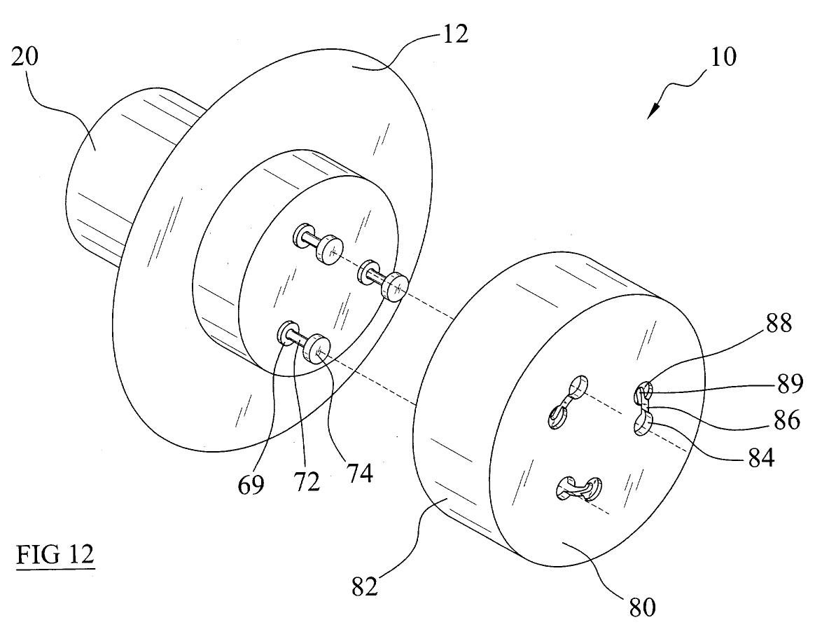

When the upper knife 12 has become worn and requires replacement, the user manipulates the position of the axle member 20 away from the lower knife. The pressure of the fluid or gas within each bore 68 is removed by relieving the pressure within. As the pressure is released from the bores 68, each compression spring 76 forces the corresponding piston member 70 outwardly toward the front of the respective bore 68 as shown in FIGS. 7 and 10 of the drawings. The pressure is preferably released so that each flanged portion 74 is extended outwardly completely from the respective recessed portion 88 within the clamp member 80. The user then rotates the clamp member 80 until each stud shaft 72 and the corresponding flanged portion 74 are aligned with a main aperture 84 as shown in FIG. 11 of the drawings. The user is then able to remove the clamp member 80 from the arbor member 60 by pulling the clamp member 80 away from the arbor member 60 as shown in FIGS. 8 and 12 of the drawings. The above-stated process is then repeated with the new upper knife 12.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A slitter knife system, comprising:
an axle member;
an arbor member rotatably positioned upon said axle member;
a plurality of bores extending into a front face of said arbor member, wherein a corresponding plurality of cap members with apertures are attached to a front end of said bores;
a second passage fluidly connected to each of said bores, wherein said second passage is fluidly connectable to a pressure source;
a compression spring positioned within each of said bores;
a piston member slidably positioned within each of said bores;
a stud shaft attached to each piston member and slidably extending through one of said cap members, wherein said stud shaft includes a flanged portion; and
a clamp member positionable about said arbor member, wherein said clamp member includes a plurality of main apertures aligned with each said flanged portion wherein said main apertures are wider than said flanged portion and a plurality of recessed portions connected to said main apertures by a slot.

2. The slitter knife system of claim 1, wherein said slot has a curved structure.

3. The slitter knife system of claim 1, wherein said slot has a constant radius of curvature measured from a center point of said clamp member.

4. The slitter knife system of claim 1, wherein said recessed portions have a shape similar to said flanged portion.

5. The slitter knife system of claim 1, wherein said recessed portions snugly receive each said flanged portion.

6. The slitter knife system of claim 1, wherein said axle member includes an inlet portion and a first passage fluidly connected to said second passage.

7. The slitter knife system of claim 6, including a connector member having a tubular structure fluidly connected between said first passage and said second passage.

8. The slitter knife system of claim 7, including a connector bearing within said axle member and wherein said connector member extends within said connector bearing concentrically.

9. The slitter knife system of claim 8, wherein said arbor member includes a receiver passage fluidly connected to said second passage and for receiving said connector member.

10. The slitter knife system of claim 1, wherein said second passage is fluidly connected to each bore near a front portion thereof for forcing said piston member rearwardly within said bore when pressurized.

11. A slitter knife system, comprising:
an arbor member;
a plurality of bores extending into a front face of said arbor member, wherein a corresponding plurality of cap members with apertures are attached to a front end of said bores;
a second passage fluidly connected to each of said bores, wherein said second passage is fluidly connectable to a pressure source;
a piston member slidably positioned within each of said bores;
a stud shaft attached to each piston member and slidably extending through one of said cap members, wherein said stud shaft includes a flanged portion; and
a clamp member positionable about said arbor member, wherein said clamp member includes a plurality of main apertures aligned with each said flanged portion wherein said main apertures are wider than said flanged portion and a plurality of recessed portions connected to said main apertures by a slot.

12. The slitter knife system of claim 11, wherein said slot has a curved structure.

13. The slitter knife system of claim 11, wherein said slot has a constant radius of curvature measured from a center point of said clamp member.

14. The slitter knife system of claim 11, wherein said recessed portions have a shape similar to said flanged portion.

15. The slitter knife system of claim 11, wherein said recessed portions snugly receive each said flanged portion.

16. The slitter knife system of claim 11, wherein said axle member includes an inlet portion and a first passage fluidly connected to said second passage.

17. The slitter knife system of claim 16, including a connector member having a tubular structure fluidly connected between said first passage and said second passage.

18. The slitter knife system of claim 17, including a connector bearing within said axle member and wherein said connector member extends within said connector bearing concentrically.

19. The slitter knife system of claim 18, wherein said arbor member includes a receiver passage fluidly connected to said second passage and for receiving said connector member.

20. The slitter knife system of claim 11, wherein said second passage is fluidly connected to each bore near a front portion thereof for forcing said piston member rearwardly within said bore when pressurized.
